(19) United States
(12) Patent Application Publication
(10) Pub. No.: US 2026/0312291 A1
(43) Pub. Date: Oct. 8, 2026

(54) ANTENNA DEVICE

(71) Applicant: Wistron NeWeb Corp., Hsinchu (TW)

(72) Inventors: CHIN-HSIEN WU, HSINCHU (TW); WEI-JIN CHEN, HSINCHU (TW); NIEN-TZU CHUNG, HSINCHU (TW); TSUN-CHE HUANG, HSINCHU (TW)

(21) Appl. No.: 19/211,491

(22) Filed: May 19, 2025

(30) Foreign Application Priority Data
Apr. 8, 2025 (TW) 114113097

(51) Int. Cl. H01Q 9/04

(52) U.S. Cl. CPC H01Q 9/0414; H01Q 9/0428

(57) ABSTRACT

An antenna device comprising a first radiation layer, a second radiation layer, a first dielectric layer, a second dielectric layer, and an excitation layer. The first radiation layer includes a first radiator, the second radiation layer includes a second radiator, the first dielectric layer includes a first hole, the second dielectric layer includes a second hole, and the excitation layer includes an excitation unit. The excitation unit is configured to excite the first radiator and the second radiator, causing the first radiator and the second radiator to radiate. The excitation layer, the first dielectric layer, the first radiation layer, the second dielectric layer, and the second radiation layer are sequentially stacked along a stacking direction. The excitation unit, the first hole, the first radiator, the second hole, and the second radiator are aligned along the stacking direction.

### CROSS-REFERENCE TO RELATED PATENT APPLICATION

This application claims the benefit of priority to Taiwan Patent Application No. 114113097, filed on April 8, 2025. The entire content of the above identified application is incorporated herein by reference.

Some references, which may include patents, patent applications and various publications, may be cited and discussed in the present disclosure. The citation and/or discussion of such references is not an admission that any such reference is “prior art” to the techniques described herein. All references cited and discussed in this specification are incorporated herein by reference in their entireties and to the same extent as if each reference was individually incorporated by reference.

### FIELD OF THE DISCLOSURE

The disclosure relates to an antenna device, particularly to an antenna device with a multi-layer stacked structure.

### BACKGROUND OF THE DISCLOSURE

Enhancing the performance of antennas and reducing costs are important aspects in the development of low earth orbit (LEO) satellite systems. Antennas used in low earth orbit satellite systems generally operate in the frequency range of 10 GHz to 15 GHz, which requires careful consideration of high-frequency characteristics of the materials used for antennas. For example, when selecting dielectric materials, it may be required for the dielectric materials to maintain stable characteristics in high-frequency bands, or it may be required for the dielectric materials to have low loss, etc. Generally speaking, high-spec materials tend to be more expensive, so one of the challenges in antenna design is to reduce the manufacturing costs of antennas while achieving good antenna performance.

### SUMMARY OF THE DISCLOSURE

An antenna device includes a first radiation layer, a second radiation layer, a first dielectric layer, a second dielectric layer, and an excitation layer. The first radiation layer includes a first radiator, the second radiation layer includes a second radiator, the first dielectric layer includes a first hole, the second dielectric layer includes a second hole, and the excitation layer includes an excitation unit. The excitation unit is configured to excite the first radiator and the second radiator, causing the first radiator and the second radiator to radiate. The excitation layer, the first dielectric layer, the first radiation layer, the second dielectric layer, and the second radiation layer are stacked sequentially along a stacking direction. The excitation unit, the first hole, the first radiator, the second hole, and the second radiator are aligned along the stacking direction.

These and other aspects of the present disclosure will become apparent from the following description of the embodiment taken in conjunction with the attached drawings and their captions.

### BRIEF DESCRIPTION OF THE DRAWINGS

The described embodiments may be better understood by reference to the following description and the accompanying drawings, in which:

FIG. 1 shows a schematic view of an antenna device according to some embodiments of the present disclosure.

FIG. 2 shows a schematic view of an excitation unit according to some embodiments of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

Those skilled in the art can understand the advantages and effects of the techniques disclosed herein from the specification and drawings. The techniques disclosed herein can be implemented or applied through various specific embodiments, and the details within this specification can be modified and changed in various ways based on different perspectives and applications without deviating from the concept of the present disclosure. Furthermore, the drawings of the present disclosure are merely illustrative and do not depict actual dimensions. The following embodiments will further detail the relevant technical content of the present disclosure, but the disclosed content is not intended to limit the scope of protection for the present disclosure. It should also be understood that although terms such as "first," "second," "third," etc. may be used in this text to describe various components, these components should not be limited by these terms. These terms are primarily used to distinguish one component from another.

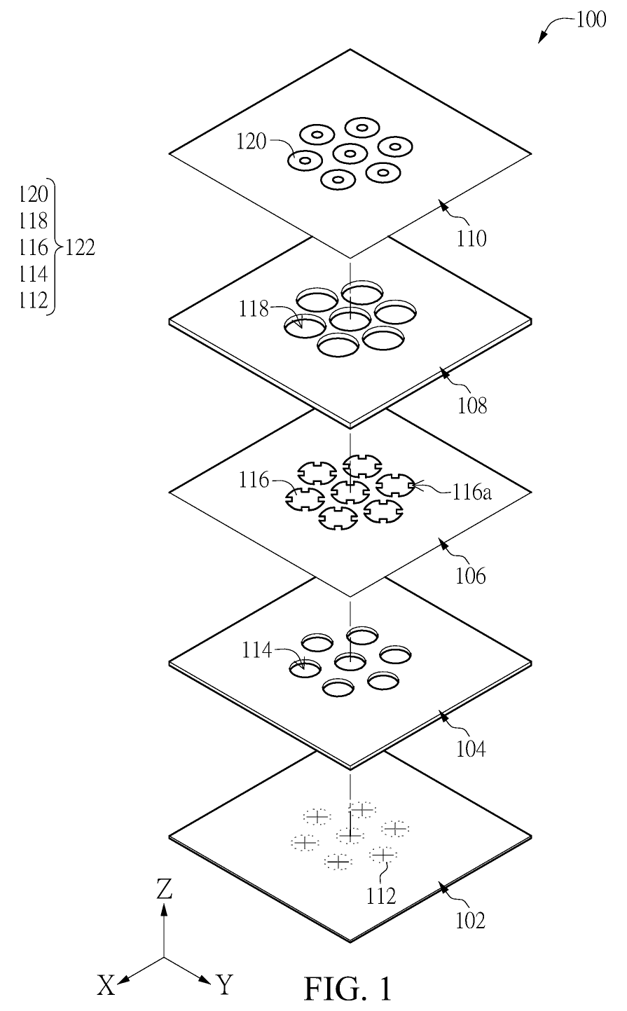

FIG. 1 shows a schematic view of an antenna device 100 according to some embodiments of the present disclosure. The antenna device 100 includes an excitation layer 102, a first dielectric layer 104, a first radiation layer 106, a second dielectric layer 108, and a second radiation layer 110. The excitation layer 102 includes an excitation unit 112; the first dielectric layer 104 includes a first hole 114; the first radiation layer 106 includes a first radiator 116; the second dielectric layer 108 includes a second hole 118; and the second radiation layer 110 includes a second radiator 120. The excitation unit 112 is configured to excite the first radiator 116 and the second radiator 120, causing the first radiator 116 and the second radiator 120 to radiate (for example, electromagnetic wave radiation). As shown in FIG. 1, the excitation layer 102, the first dielectric layer 104, the first radiation layer 106, the second dielectric layer 108, and the second radiation layer 110 are stacked sequentially along the stacking direction (for example, the Z-axis direction). As a result of the aforementioned stacking, the first dielectric layer 104 is positioned between the excitation layer 102 and the first radiation layer 106, while the second dielectric layer 108 is positioned between the first radiation layer 106 and the second radiation layer 110. Accordingly, the excitation unit 112 located in the excitation layer 102, the first radiator 116 located in the first radiation layer 106, and the second radiator 120 located in the second radiation layer 110 do not directly contact each other.

The excitation unit 112, the first hole 114, the first radiator 116, the second hole 118, and the second radiator 120 are aligned along the stacking direction, such that the first hole 114 is positioned between the excitation unit 112 and the first radiator 116, and the second hole 118 is positioned between the first radiator 116 and the second radiator 120. The stacked structure formed by the excitation unit 112, the first hole 114, the first radiator 116, the second hole 118, and the second radiator 120 aligned along the stacking direction can be regarded as an antenna unit 122, and the antenna device 100 may include multiple antenna units 122 to form an antenna array. Although FIG. 1 shows seven antenna units 122, the antenna device 100 may include more or fewer antenna units 122. In some embodiments, a processor (not shown) may be used to control the antenna units 122 in the antenna array, and each antenna unit 122 may be controlled independently or together. The radiation between different antenna units 122 may mutually influence each other, thereby forming the overall radiation pattern of the antenna device 100; this technique is referred to as "beamforming" in related fields.

The first dielectric layer 104 and the second dielectric layer 108 may be formed from dielectric materials such as ABS (Acrylonitrile Butadiene Styrene) plastic. In the first dielectric layer 104, the dielectric material at the first hole 114 is removed, allowing radiation from the excitation unit 112 to be transmitted to the first radiator 116 via a medium (such as air or vacuum) in the first hole 114. Similarly, in the second dielectric layer 108, the dielectric material at the second hole 118 is removed, allowing radiation from the excitation unit 112 and/or the first radiator 116 to be transmitted to the second radiator 120 via a medium (such as air or vacuum) in the second hole 118. Accordingly, energy coupling can occur between the excitation unit 112, the first radiator 116, and the second radiator 120.

The first hole 114 and the second hole 118 of the antenna device 100 are designed to allow radiation to be transmitted between the excitation unit 112, the first radiator 116, and the second radiator 120 with air as the primary medium. Using air as the transmission medium has many advantages; for example, the dielectric constant (Dk) of air does not vary significantly with frequency, and the loss factor (Df) of air is low, resulting in less signal attenuation. This reduces the influence of dielectric material characteristics of the first dielectric layer 104 and the second dielectric layer 108 on the antenna device 100. Therefore, in the application of low earth orbit satellite systems which have strict specification requirements, the performance of the antenna device 100 can still be maintained even when using cheaper or lower-spec dielectric materials (such as ABS plastic) to fabricate the first dielectric layer 104 and the second dielectric layer 108, thus reducing manufacturing costs of the antenna device 100.

The sizes of the first hole 114 and the second hole 118 can be selected to be large enough to allow radiation to be transmitted between the excitation unit 112, the first radiator 116, and the second radiator 120 using air as the primary medium. For example, the projection region defined by projecting the first radiator 116 in the stacking direction (for example, the Z-axis direction) may be completely located within the first hole 114 and/or the second hole 118, and the projection region defined by projecting the second radiator 120 in the stacking direction may also be completely located within the first hole 114 and/or the second hole 118. FIG. 1 shows that the first hole 114 and the second hole 118 have a circular shape, but the first hole 114 and the second hole 118 may also be configured in other shapes, such as rectangular or other polygons, etc. Furthermore, the shapes and sizes of the first hole 114 and the second hole 118 may be the same or different.

The substrates of the first radiation layer 106 and the second radiation layer 110 may be formed from dielectric materials, while the first radiator 116 and the second radiator 120 respectively disposed on the first radiation layer 106 and the second radiation layer 110 may be formed from metal. The first radiator 116 and the second radiator 120 of the antenna device 100 may be patch antennas, and in some alternative embodiments, the first radiator 116 and the second radiator 120 may also be other types of antennas. The first radiator 116, once excited by the excitation unit 112, can already generate a radiation field, but stacking the second radiator 120 above the first radiator 116 for energy coupling can further improve the radiation characteristics of the antenna device 100, such as enhancing the radiation gain or broadening the bandwidth of the antenna device 100. The first radiator 116 and the second radiator 120 may have various shapes, and the shapes and sizes of the first radiator 116 and the second radiator 120 may be the same or different. In FIG. 1, the first radiator 116 has a circular shape, and the second radiator 120 has an annular shape. The edges of the circular shape of the first radiator 116 may have one or more notches 116a (FIG. 1 shows four notches 116a for each circular shape of the first radiator 116) to adjust the impedance matching of the first radiator 116. The annular shape of the second radiator 120 may also be used to adjust the impedance matching. In some alternative embodiments, the first radiator 116 and the second radiator 120 may have the same shape, such as both being circular, annular, polygonal, or other shapes.

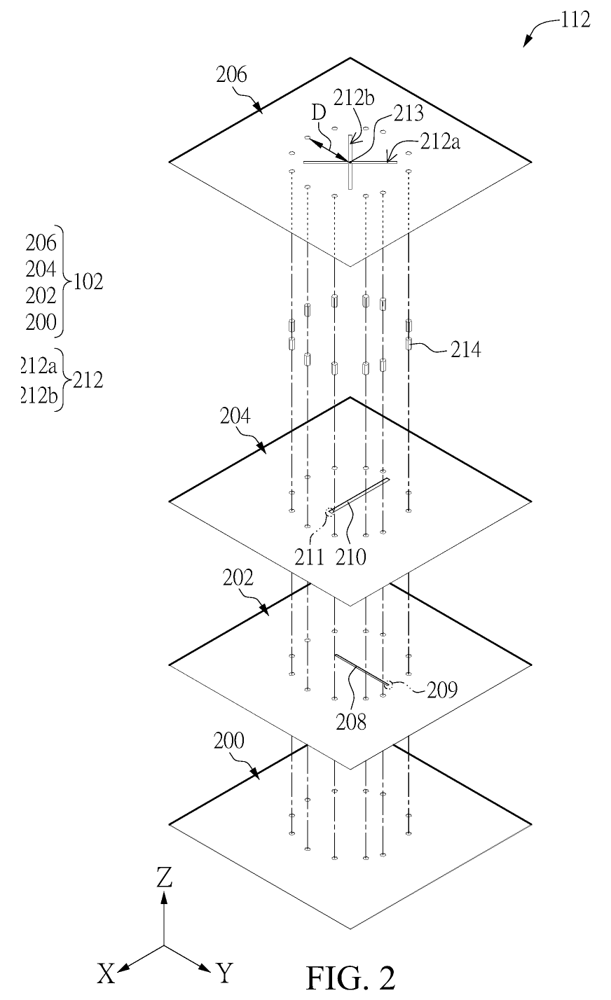

The excitation unit 112 is capable of generating a circularly polarized radiation to excite the first radiator 116 and the second radiator 120. The first radiator 116 and the second radiator 120 excited by the excitation unit 112 may also generate circularly polarized radiation. Circularly polarized radiation allows signals to be less affected by interference from other signals in the external environment during transmission and reception, making it particularly advantageous in applications for low earth orbit satellite systems. The excitation unit 112 is located in the excitation layer 102, and the excitation layer 102 may be a multi-layer board. The structure of the excitation unit 112 will be described in FIG. 2.

FIG. 2 shows a schematic view of the excitation unit 112 according to some embodiments of the present disclosure. The antenna device may include one or more excitation units 112 (for example, FIG. 1 shows seven excitation units 112), while FIG. 2 illustrates only one excitation unit 112 for explanation. As previously mentioned, the excitation unit 112 is located in the excitation layer 102, and the excitation layer 102 may be a multi-layer board. As shown in FIG. 2, the excitation layer 102 may include a ground layer 200, a first microstrip layer 202, a second microstrip layer 204, and a slot layer 206. Additionally, the ground layer 200, the first microstrip layer 202, the second microstrip layer 204, and the slot layer 206 are stacked sequentially along the stacking direction (for example, the Z-axis direction). The excitation unit 112 may include a slot structure 212, a first microstrip 208, and a second microstrip 210, wherein the slot structure 212 is located in the slot layer 206, the first microstrip 208 is located in the first microstrip layer 202, and the second microstrip 210 is located in the second microstrip layer 204. The slot structure 212 may penetrate through the slot layer 206. The excitation unit 112 may also include plurality of vias 214, each via 214 connecting the ground layer 200 and the slot layer 206 by passing through the first microstrip layer 202 and the second microstrip layer 204. The ground layer 200 and the slot layer 206 may be formed from metal, and the vias 214 may or may not pass through the ground layer 200 and the slot layer 206 for connection.

The substrates of the first microstrip layer 202 and the second microstrip layer 204 may be formed from dielectric materials, while the first microstrip 208 and the second microstrip 210 respectively disposed on the first microstrip layer 202 and the second microstrip layer 204 may be formed from metal. The first microstrip 208 and the second microstrip 210 may extend in different directions; for example, the first microstrip 208 may extend along the Y-axis direction, and the second microstrip 210 may extend along the X-axis direction, making the first microstrip 208 and the second microstrip 210 perpendicular to each other. A first feed port 209 may be located at the first microstrip 208 (for example, at one end of the first microstrip 208), and a second feed port 211 may be located at the second microstrip 210 (for example, at one end of the second microstrip 210). Signals may be fed in through the first feed port 209 and the second feed port 211, and may be grounded through the ground layer 200. In some embodiments, the first feed port 209 is configured to feed a first signal, and the second feed port 210 is configured to feed a second signal, and the phase difference between the first signal and the second signal is 90 degrees so as to generate circularly polarized radiation. After the signals are fed in through the first feed port 209 and the second feed port 211, they can further excite the slot structure 212 for radiation.

The slot structure 212 may include a first slot 212a and a second slot 212b located in the slot layer 206, wherein the first slot 212a and the second slot 212b may be arranged to form a cross shape, and the first slot 212a and the second slot 212b may penetrate through the slot layer 206. In this embodiment, the first slot 212a and the second slot 212b are positioned to form a 90-degree angle to each other, but in alternative embodiments, other angles may also be formed. To enhance the excitation efficiency of the slot structure 212, the first microstrip 208, the second microstrip 210, the first slot 212a, and the second slot 212b may extend in different directions; for example, the first microstrip 208 may extend along the Y-axis direction, the second microstrip 210 may extend along the X-axis direction, the first slot 212a may extend at a 45 degree angle from the X-axis direction, and the second slot 212b may extend at a negative 45 degree angle from the X-axis direction.

The plurality of vias 214 may be arranged to surround the first microstrip 208 in the first microstrip layer 202 and surround the second microstrip 210 in the second microstrip layer 204. Additionally, the plurality of vias 214 may also be arranged to surround the slot structure 212 in the slot layer 206. The configuration of the plurality of vias 214 surrounding the first microstrip 208, the second microstrip 210, and the slot structure 212 can reduce the amount of radiation from the first microstrip 208, the second microstrip 210, and the slot structure 212 spreading in the radial direction (for example, spreading in the X-Y plane). Accordingly, since the excitation unit 112 has less radiation waste in the X-Y plane, it can more effectively concentrate energy in the Z-axis direction to excite the first radiator 116 and the second radiator 120. Furthermore, the plurality of vias 214 can also reduce mutual radiation interference between different excitation units 112. In some embodiments, to further enhance the efficiency of the excitation unit 112 in exciting the first radiator 116 and the second radiator 120, the projection region defined by projecting the first radiator 116 and/or the second radiator 120 in the stacking direction (for example, the Z-axis direction) may completely cover the plurality of vias 214 of the excitation unit 112, allowing the first radiator 116 and/or the second radiator 120 to have more area to receive radiation from the excitation unit 112.

The cross shape of the slot structure 212 may have a central point 213, and the distance D from any via 214 to the central point 213 may be greater than half of the length of the first slot 212a or half of the length of the second slot 212b, allowing the plurality of vias 214 to completely surround the slot structure 212 in the slot layer 206. In this embodiment, the plurality of vias 214 are arranged in a circular pattern, and the distance D from each via 214 to the central point 213 is the same. In alternative embodiments, the plurality of vias 214 may be arranged in other shapes, and the distances D from individual vias 214 to the central point 213 may differ; for example, in a rectangular arrangement of the plurality of vias 214, the distances D from individual vias 214 to the central point 213 may vary.

The antenna device 100 may be configured to operate in a frequency band, and a length of the first slot 212a and a length of the second slot 212b may correspond to 0.25 to 0.5 times a wavelength corresponding to the frequency band.

Overall, the design of the antenna device 100 of the present disclosure allows radiation to be primarily transmitted in air rather than in dielectric materials between the excitation unit 112, the first radiator 116, and the second radiator 120, thereby reducing the reliance of the antenna device 100 on the specifications of dielectric materials. This allows the use of cheaper or lower-spec dielectric materials for fabricating the first dielectric layer 104 and the second dielectric layer 108, resulting in cost savings.

Even in a cost-saving scenario, the antenna device 100 of the present disclosure can still achieve good antenna performance. For example, the overlap between the first radiator 116 and the second radiator 120 can increase the gain of the antenna device 100 and widen the bandwidth, and the excitation unit 112 can generate circularly polarized radiation to excite the first radiator 116 and the second radiator 120, allowing both the first radiator 116 and the second radiator 120 to also generate circularly polarized radiation to reduce interference from other signals in the external environment. Furthermore, the arrangement of the vias 214 surrounding the first microstrip 208, the second microstrip 210, and the slot structure 212 can reduce the amount of radiation spreading in the radial direction, allowing the radiation of the excitation unit 112 to be more concentrated in exciting the first radiator 116 and the second radiator 120, thereby increasing excitation efficiency. Other advantages of the antenna device 100 of the present disclosure are not exhaustively listed here.

The foregoing embodiments were chosen and described in order to explain the principles of the present disclosure and their practical applications. Alternative embodiments will become apparent to those skilled in the art to which the present disclosure pertains without departing from its spirit and scope.

What is claimed is:

1. An antenna device, comprising:
a first radiation layer, comprising a first radiator;
a second radiation layer, comprising a second radiator;
a first dielectric layer, comprising a first hole;
a second dielectric layer, comprising a second hole; and
an excitation layer, comprising an excitation unit configured to excite the first radiator and the second radiator, causing the first radiator and the second radiator to radiate;
wherein:
the excitation layer, the first dielectric layer, the first radiation layer, the second dielectric layer, and the second radiation layer are stacked sequentially along a stacking direction; and
the excitation unit, the first hole, the first radiator, the second hole, and the second radiator are aligned along the stacking direction.

2. The antenna device according to claim 1, wherein:
the excitation layer comprises:
a ground layer;
a first microstrip layer;
a second microstrip layer; and
a slot layer;
the ground layer, the first microstrip layer, the second microstrip layer, and the slot layer are stacked sequentially along the stacking direction; and
the excitation unit comprises:
a slot structure located in the slot layer;
a first microstrip located in the first microstrip layer; and
a second microstrip located in the second microstrip layer.

3. The antenna device according to claim 2, wherein the excitation unit further comprises a plurality of vias, each via of the plurality of vias passes through the first microstrip layer and the second microstrip layer to connect the ground layer to the slot layer.

4. The antenna device according to claim 3, wherein the plurality of vias are arranged to surround the first microstrip in the first microstrip layer and surround the second microstrip in the second microstrip layer.

5. The antenna device according to claim 2, wherein the first microstrip and the second microstrip are perpendicular to each other.

6. The antenna device according to claim 3, wherein the slot structure comprises a first slot and a second slot located in the slot layer, and the first slot and the second slot are arranged to form a cross shape.

7. The antenna device according to claim 6, wherein the first slot and the second slot penetrate through the slot layer.

8. The antenna device according to claim 6, wherein the first microstrip, the second microstrip, the first slot, and the second slot extend in different directions.

9. The antenna device according to claim 6, wherein the antenna device is configured to operate in a frequency band, and a length of the first slot and a length of the second slot are 0.25 to 0.5 times a wavelength corresponding to the frequency band.

10. The antenna device according to claim 6, wherein the cross shape has a central point, and in the slot layer, a distance from any via among the plurality of vias to the central point is greater than half of a length of the first slot or half of a length of the second slot.

11. The antenna device according to claim 2, wherein the excitation unit comprises:
a first feed port located at the first microstrip; and
a second feed port located at the second microstrip.

12. The antenna device according to claim 11, wherein the first feed port is configured to feed a first signal, the second feed port is configured to feed a second signal, and a phase difference between the first signal and the second signal is 90 degrees.

13. The antenna device according to claim 1, wherein a projection region defined by projecting the first radiator in the stacking direction is completely located within the first hole and/or the second hole.

14. The antenna device according to claim 1, wherein a projection region defined by projecting the second radiator in the stacking direction is completely located within the first hole and/or the second hole.

15. The antenna device according to claim 4, wherein a projection region defined by projecting the first radiator in the stacking direction completely covers the plurality of vias.

16. The antenna device according to claim 4, wherein a projection region defined by projecting the second radiator in the stacking direction completely covers the plurality of vias.

17. The antenna device according to claim 1, wherein the first radiator has a circular shape, and the circular shape has a notch.

18. The antenna device according to claim 1, wherein the second radiator has an annular shape.

19. The antenna device according to claim 1, wherein the excitation unit is configured to generate a circularly polarized radiation.

20. The antenna device according to claim 2, wherein the slot layer is made of metal.
